(19) United States
(12) Patent Application Publication
(10) Pub. No.: US 2007/0186590 A1
(43) Pub. Date: Aug. 16, 2007

(54) Mold for glass

(75) Inventors: Wen-Jen Liao, Taipei Hsien (TW); Jen-Sheuan Huang, Hsinchu Hsien (TW); Hsiao-Kuo Chang, Tainan (TW)

Correspondence Address: BACON & THOMAS, PLLC, 625 SLATERS LANE, FOURTH FLOOR, ALEXANDRIA, VA, 22314, US

(73) Assignee: KINIK COMPANY, Taipei (TW)

(21) Appl. No.: 11/350,832

(22) Filed: Feb. 10, 2006

(51) Int. Cl. C03B 11/08; C03B 7/14

(52) U.S. Cl. 65/374.13; 65/374.15

(57) ABSTRACT

A mold for glass has a base and a diamond protective film deposited on the base. Due to the quality of the diamond protective film, the base can be protected substantially with a high temperature in the process of manufacturing the glass to extend the lifespan of the mold.

### BACKGROUND OF THE INVENTION

1. Field of the Invention

The present invention relates to a mold for, and more particularly to a mold for glass and that has a diamond film mounted thereon.

2. Description of the Related Art

A first conventional technique for shaping glass is a step of grinding, polishing and cleaning. However, the first conventional technique for shaping glass is disadvantage for providing glass with aspheric surfaces.

A second conventional technique for shaping glass is used with a mold. With reference to FIGS. 1, the second conventional technique for shaping glass comprises an upper mold (1) and a lower mold (2) detachably combined with the upper mold (1). Glass (3) is provided between the upper mold (1) and the lower mold (2). The glass (3) is heated to soften and then is compressed by the upper mold (1) and the lower mold (2) to form a desired shape. When the temperature of the glass (3) is lowered, the glass (3) has a desired shaped corresponding to the pattern of the upper mold (1) and the lower mold (2). Because the upper mold (1) and the lower mold (2) contact with the glass (3) at high temperature during the processes of shaping glass, such that the surfaces of the upper mold (1) and the lower mold (2) are deteriorated quickly and the useful life of the mold is shortened.

Hence, a protective film is always deposited on and protects the surfaces of the upper mold (1) and the lower mold (2). The functions of the protective film are described as follows:

1. The protective film enables the glass not to adhere to the surfaces of the upper mold and the lower mold.

2. The protective film can prevent the upper mold and the lower mold from oxidizing.

3. The protective film can prevent the upper mold and the lower mold form deteriorating.

A first conventional protective film is noble metal films such as an alloy of Pt-Ir, an alloy of Re-Ir, etc, which has a good adhesion to mold comprising tungsten carbide. However, the first conventional protective film is also easy to adhere to the glass. A second conventional protective film is ceramic films such as SiC, which is difficult to adhere to the mold. A third conventional protective film is Diamond Like Carbon which can not sustain high temperature of glass. Hence, different kinds of glass are used with various molds having different protective films thereby causing a high cost.

Therefore, the invention provides a mold for glass to mitigate or obviate the aforementioned problems.

### SUMMARY OF THE INVENTION

The main objective of the present invention is to provide a mold for glass and that is proper for different kinds of glasses and has a long lifespan.

Other objectives, advantages and novel features of the invention will become more apparent from the following detailed description when taken in conjunction with the accompanying drawings.

### BRIEF DESCRIPTION OF THE DRAWINGS

FIG. 1 is a sectional view of a conventional mold for glass in accordance with the prior art;

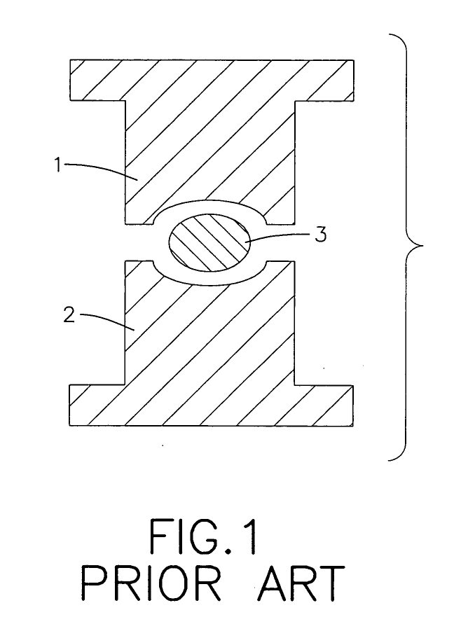

FIG. 2 is side plan view in partial section of a first preferred embodiment of a mold for glass in accordance with the present invention; and

FIG. 3 is a side plan view in partial section of a second preferred embodiment of a mold for glass in accordance with the present invention.

### DETAILED DESCRIPTION OF THE PREFERRED EMBODIMENT

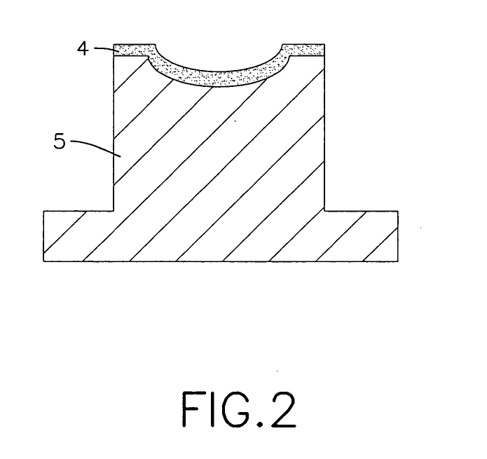

With reference to FIGS. 2, a first preferred embodiment of the present invention has a diamond protective film (4) and a base (5). The diamond protective film (4) is provided by deposition technique and substantially made of pure diamond. The base (5) is made of ceramic materials such as carborundum, silicon nitride, aluminium nitride, silicide, etc, which has the same expansion rate as that of the diamond protective film (4).

The base (5) has a top recess defined in the top and having a desired shape such as a spherical inner surface. The diamond protective film (4) is coated onto the top recess in the base (5) with deposition technique. The diamond protective film (4) has 0.2-40 μm in thickness. When the thickness of the diamond protective film (4) is much than 40 μtm, the diamond protective film (4) is easy to separate from the base (5). When the thickness of it is less than 0.2 μm, the diamond protective film (4) can not provide an enough protecting effect to the base (5). The diamond protective film (4) has a crystal configuration, and the range of thickness of the film (4) is from 20 nm to 20 μm. If the Full Width at Half Maximum thickness of the diamond protective film (4) is from 1.5 cm⁻¹ to 14cm⁻¹, a rough surface is provided on the diamond protective film (4). Hence, surfaces of the diamond protective film (4) are polished to enable the roughness of the surfaces is less than Ra10 nm.

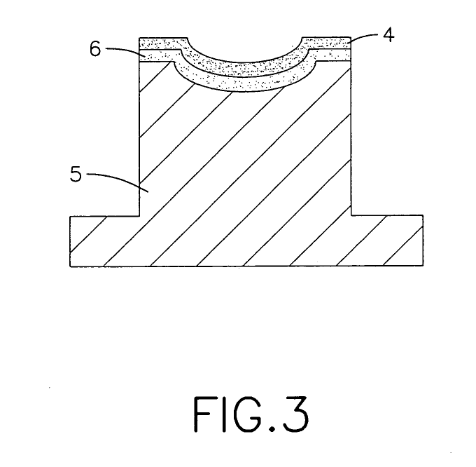

With reference to FIG. 3, a second preferred embodiment of the present invention is similar to the first preferred embodiment except that before the diamond protective film (4) is deposited onto the base (5), at least one layer (6) is provided between the base (5) and the diamond protective film (4) to enhance the adhesion of the diamond protective film (4).

The use of the first preferred embodiment and the second preferred embodiment of the mold for glass are respectively similar to that of the conventional mold for glass. The mold is provided into a chamber full of nitrogen or vacuum to avoid the mold and glass from oxidizing. The temperature for shaping glass ranges from about 350° C. to about 650° C. The diamond protective film (4) can bear the high temperature of the fluid glass and has an effect of auto-adhesion and a low friction factor, so that the surface of the base (5) can be protected. Due to the high rigidity of the diamond protective film (4), the surfaces of the diamond protective film (4) is difficult to be worn off. The diamond protective film (4) has a good tolerance of anticorrosion with acid, alkali, even aqua regia, so that the diamond protective film (4) doesn't react with the fluid glass. The diamond protective film (4) conducts heat quickly, so that the heat can be conducted into or out of the base (5) and glass to shorten the process period of shaping.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A mold for glass comprising:
a base made of ceramic material with an expansion factor similar to that of a diamond and having
a top recess with an inner surface defined in a top of the base; and
a diamond protective film coated on the inner surface of the top recess by deposition.

2. The mold for glass as claimed in claim 1, wherein the base is made of carborundum.

3. The mold for glass as claimed in claim 1, wherein the base is made of silicon nitride.

4. The mold for glass as claimed in claim 1, wherein the base is made of aluminium nitride.

5. The mold for glass as claimed in claim 1, wherein the base is made of silicide.

6. The mold for glass as claimed in claim 1, wherein at least one layer is mounted between the diamond protective film and the base.

7. The mold for glass as claimed in claim 6, wherein the diamond protective film has surface with a roughness less than Ra10 nm.

8. The mold for glass as claimed in claim 7, wherein the inner surface of the top recess in the base is spherical.
